(19) United States
(12) Patent Application Publication
(10) Pub. No.: US 2018/0150982 A1
(43) Pub. Date: May 31, 2018

(54) FACILITATING DIGITAL DATA TRANSFERS USING VIRTUAL REALITY DISPLAY DEVICES

(71) Applicant: BANK OF AMERICA CORPORATION, CHARLOTTE, NC (US)

(72) Inventors: Jisoo Lee, Chesterfield, NJ (US); Graham M. Wyllie, Charlotte, NC (US); Victoria L. Dravneek, Charlotte, NC (US); Joseph N. Johansen, Rock Hill, SC (US); Elizabeth S. Votaw, Potomac, MD (US)

(21) Appl. No.: 15/363,185

(22) Filed: Nov. 29, 2016

(51) Int. Cl. G06T 11/60; H04L 29/06; G06Q 40/00

(52) U.S. Cl. CPC G06T 11/60; H04L 63/0861; G06F 3/0482; G06Q 40/12; H04L 63/123

(57) ABSTRACT

A virtual reality system including a virtual reality user device with a display that presents a virtual reality environment to a user, an electronic transfer engine, and a virtual overlay engine. The electronic transfer engine identifies a user token for a user and sends the user token to a remote server. The user token requests virtual data with a document and a status tag for the document identifying the current status of the document for the user. The virtual overlay engine presents the document in the virtual reality environment and overlays the status tag onto the document in the virtual reality environment. The virtual reality system also includes a remote server with a transfer management engine that receives the user token and sends the virtual data to the virtual reality user device based on the user token.

### TECHNICAL FIELD

The present disclosure relates generally to performing operations using a virtual reality display device that presents virtual objects in a virtual reality environment.

### BACKGROUND

When a person receives an electronic document, they may want to find information related to the document and/or to determine whether there are any actions that need to be taken for the document. The information the person is looking for may be distributed among multiple sources and databases. Using existing systems, when a person is looking for information located among different databases with different sources, the person has to make individual data requests to each of the different sources in order to obtain the desired information. The process of making multiple data requests to different data sources requires a significant amount of processing resources to generate the data requests. Typically processing resources are limited and the system is unable to perform other tasks when processing resources are occupied which degrades the performance of the system.

The process of sending multiple data requests and receiving information from multiple sources occupies network resources until all of the information has been collected. This process poses a burden on the network which degrades the performance of the network. Thus, it is desirable to provide the ability to securely and efficiently request information from multiple data sources.

### SUMMARY

In one embodiment, the disclosure includes a virtual reality system that includes a virtual reality user device for a user. The virtual reality user device includes a display that presents a virtual reality environment to the user. The virtual reality user device also includes a memory that stores verification data used to authenticate users and user tokens that uniquely identify users.

The virtual reality user device also has one or more processers coupled to the display and the memory. The processors implement an electronic transfer engine and a virtual overlay engine. The electronic transfer engine receives a user input identifying a user and compares the user input to the verification data to authenticate the user. The electronic transfer engine also identifies a user token for the user and sends the user token to a remote server. The user token is used to request virtual data for the user such as a document, a status tag for the document identifying the current status of the document, and one or more transfer options for the user. The electronic transfer engine encrypts the user token and sends the user token to a remote server. The electronic transfer engine receives the virtual data for the user in response to sending the user token. The electronic transfer engine then determines whether the status tag indicates the document is unpaid.

The virtual overlay engine presents the document in the virtual reality environment and overlays the status tag onto the document in the virtual reality environment. The virtual overlay engine presents the one or more transfer options for the document in the virtual reality environment when the status tag indicates the document is unpaid. The electronic transfer engine identifies a selected transfer option from the one or more transfer options and sends a message identifying the selected transfer option to the remote server.

The virtual reality system also includes a remote server with a transfer management engine. The transfer management engine receives the user token and decrypts the user token. The transfer management engine then identifies account information for the user based on the user token. The transfer management engine then obtains the document for the user based on the account information. The transfer management engine determines whether the document is unpaid based on the account information and links the document with the status tag indicating the document is unpaid when the document is unpaid. The transfer management engine also determines the one or more transfer options for the user based on the account information and send the virtual data to the virtual reality user device.

The present embodiment presents several technical advantages. In one embodiment, a virtual reality user device allows a user to reduce the number of requests used to obtain information from multiple data sources. Additionally, the virtual reality user device allows the user to authenticate themselves which allows the user to request and obtain information that is specific to the user without having to provide different credentials to authenticate the user with each data source.

The amount of processing resources used for the reduced number of requests is significantly less than the amount of processing resources used by existing systems. The overall performance of the system is improved as a result of consuming less processing resources. Reducing the number of data requests also reduces the amount of data traffic required to obtain information from multiple sources which results in improved network utilization and network performance.

The virtual reality user device generates user tokens that identify the user which improves the performance of the virtual reality user device by reducing the amount of information required to identify and authenticate the user. Using user token also reduces the amount information used to request information linked with the user. User tokens are encoded or encrypted to obfuscate and mask information being communicated across a network. Masking the information being communicated protects users and their information in the event of unauthorized access to the network and/or data occurs.

Another technical advantage is the virtual reality user device allows a user to view information for linked with documents and the user as virtual objects in a virtual reality environment in real time. This allows the user to quickly view information for multiple documents that are virtually in front of the user in a virtual reality environment.

Another technical advantage is the virtual reality user device provides a virtual reality environment where information can only be seen by the virtual reality user device user. This provides privacy to the user's information and increases the security of the overall system.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a virtual reality system configured to present virtual objects in a virtual reality environment;

FIG. 2 is a first person view of an embodiment for a virtual reality user device display presenting virtual objects within a virtual reality environment;

FIG. 3 is a first person view of another embodiment for a virtual reality user device display presenting virtual objects within a virtual reality environment;

FIG. 4 is a schematic diagram of an embodiment of a virtual reality user device employed by the virtual reality system;

FIG. 5 is a flowchart of an embodiment of a virtual reality overlaying method; and

FIG. 6 is a flowchart of another embodiment of a virtual reality overlaying method.

### DETAILED DESCRIPTION

When a person is reviewing a physical or electronic document, the person may need different kinds of information from multiple sources in order to make a decision about how to deal with the document. For example, the person may want to look-up information about the document, their personal information, and their previous actions or history with the document. All of this information may be located in different databases with different sources which results in several technical problems.

Using existing systems, the person has to make individual data requests to each of the different sources in order to obtain the desired information. The process of making multiple data requests to different data sources requires a significant amount of processing resources to generate the data requests. Typically processing resources are limited and the system is unable to perform other tasks when processing resources are occupied which degrades the performance of the system. The process of sending multiple data requests and receiving information from multiple sources occupies network resources until all of the information has been collected. This process poses a burden on the network which degrades the performance of the network.

Additionally, each data request may require different credentials to authenticate the person with each of the different sources. Providing different credentials to each source increases the complexity of the system and increases the amount of data that is sent across the network. The increased complexity of the system makes existing systems difficult to manage. The additional data that is sent across the network both occupies additional network resources and exposes additional sensitive information to network.

A technical solution to these technical problems is a virtual reality user device that allows a user to reduce the number of data requests used to obtain information from multiple sources. The virtual reality user device allows the user to authenticate themselves to obtain information that allows the user to request and obtain personal information that is specific to the user without having to provide different credentials to authenticate the user with each data source. The amount of processing resources used for the reduced number of data requests is significantly less than the amount of processing resources used by existing systems. The overall performance of the system is improved as a result of consuming less processing resources. Using a reduced number of data requests to obtain information from multiple sources reduces the amount of data traffic required to obtain the information which results in improved network utilization and network performance.

Securely transferring data and information across a network poses several technical challenges. Networks are susceptible to attacks by unauthorized users trying to gain access to sensitive information being communicated across the network. Unauthorized access to a network may compromise the security of the data and information being communicated across the network.

One technical solution for improving network security is a virtual reality user device that generates and uses user tokens to allow a user to send information for requesting potentially sensitive information for the user. The virtual reality user device allows user tokens to be generated automatically upon identifying and authenticating the user. The user token may be encoded or encrypted to obfuscate the information being communicated by it. Using user tokens to mask information that is communicated across the network protects users and their information in the event of unauthorized access to the network and/or data occurs. The user tokens also allow for data transfers to be executed using less information than other existing systems, and thereby reduces the amount of data that is communicated across the network. Reducing the amount of data that is communicated across the network improves the performance of the network by reducing the amount of time network resource are occupied.

In addition to providing several technical solutions to these technical challenges, a virtual reality user device allows a user view information for multiple documents and the user as virtual objects in a virtual reality environment. For example, using the virtual reality user device, the user is able to quickly view information for multiple documents that are virtually in front of the user. The user is able to view information about the document, their personal information, and/or their previous actions or history with the document as a virtual object in a virtual reality environment.

Information in a virtual reality environment can only be seen by the user of the virtual reality user device. Other people around the virtual reality user device user are unable to see any potentially sensitive information the user is viewing. As a result, the virtual reality user device provides privacy to the user's information and increases the security of the overall system.

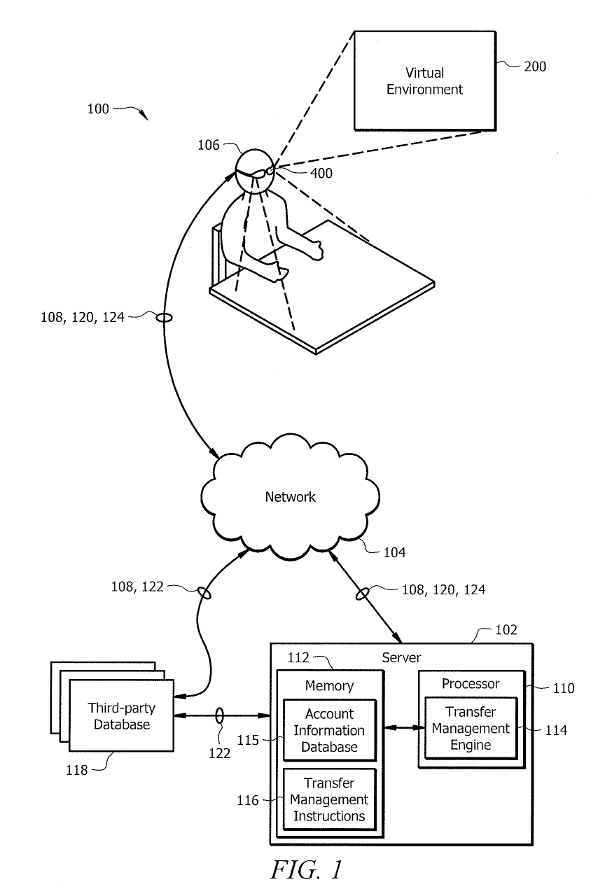

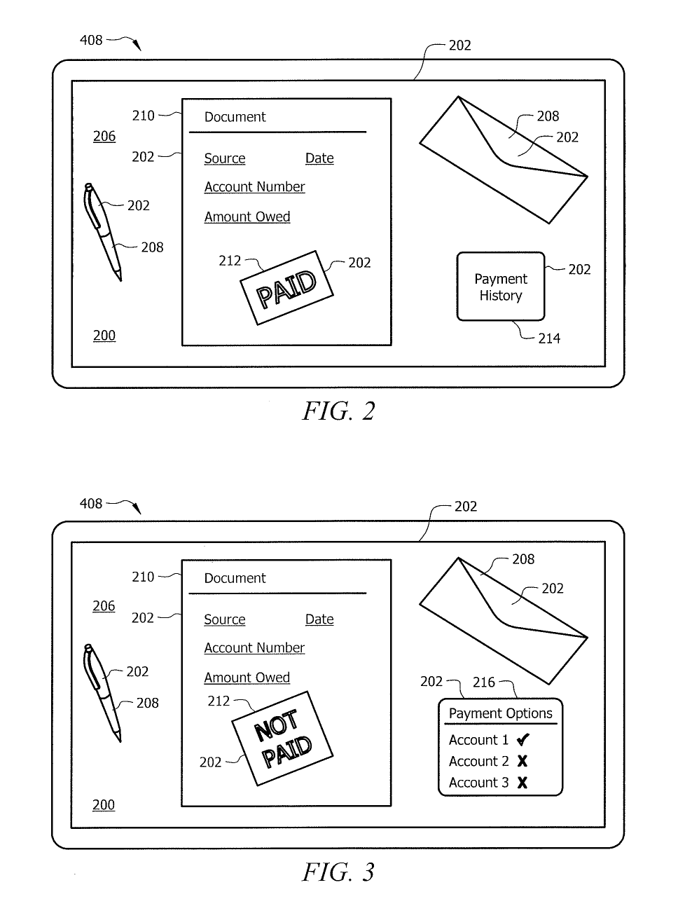

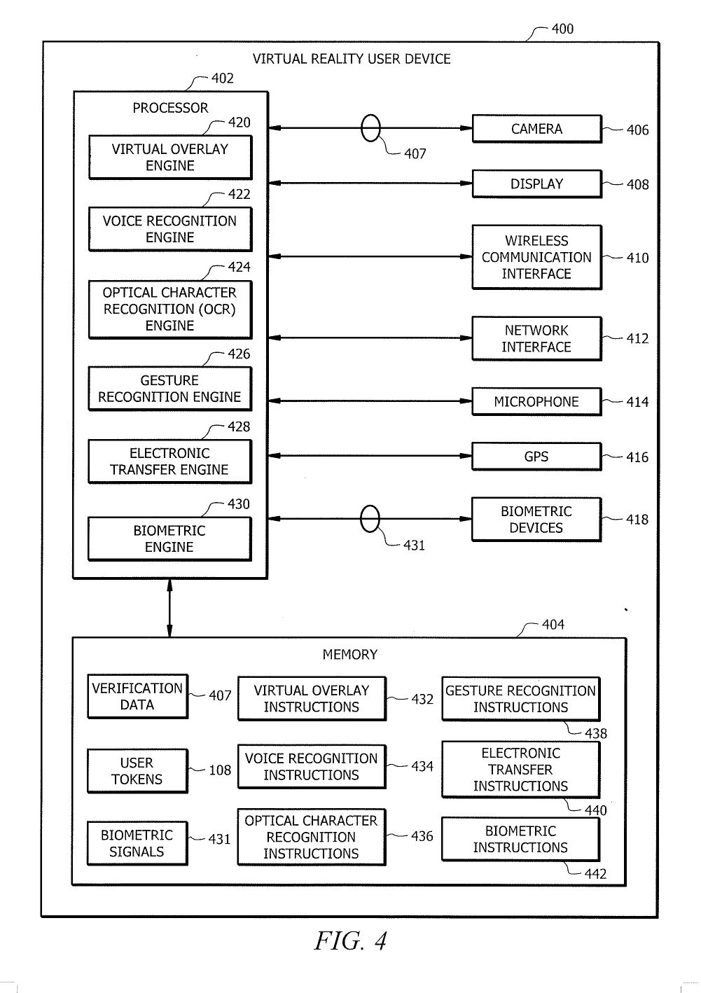

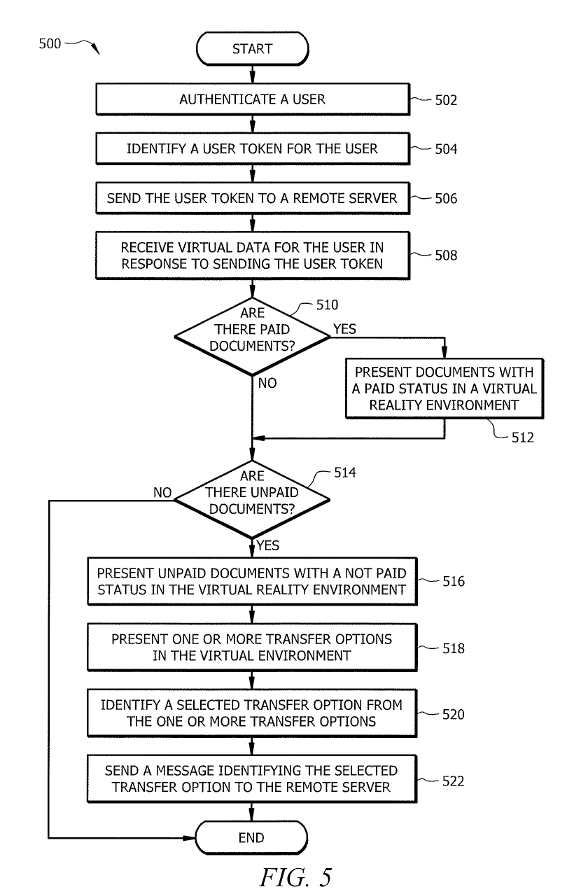

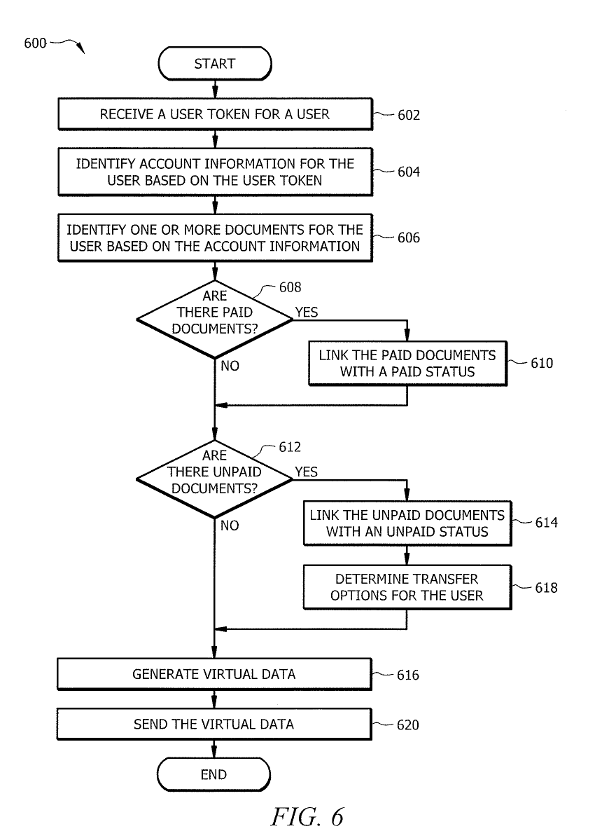

FIG. 1 illustrates a user employing a virtual reality user device to view virtual objects in a virtual environment. FIGS. 2 and 3 provide first person views of what a user might see when using the virtual reality user device to view virtual objects in the virtual environment. FIG. 4 is an embodiment of how a virtual reality user device may be configured and implemented. FIGS. 5 and 6 are examples of a process for retrieving and presenting virtual objects in a virtual reality environment using a virtual reality user device and a server, respectively.

FIG. 1 is a schematic diagram of an embodiment of a virtual reality system 100 configured to present virtual objects in a virtual reality environment 200. The virtual reality system 100 comprises a virtual reality user device 400 in signal communication with a remote server 102 via a network 104. The virtual reality user device 400 is configured to employ any suitable connection to communicate data with the remote server 102. In FIG. 1, the virtual reality user device 400 is configured as a head-mounted wearable device. Other examples of wearable devices are integrated into a contact lens structure, an eye glass structure, a visor structure, a helmet structure, or any other suitable structure. In some embodiments, the virtual reality user device 400 comprises a mobile user device integrated with the head-mounted wearable device. Examples of mobile user devices include, but are not limited to, a mobile phone and a smart phone. Additional details about the virtual reality user device 400 are described in FIG. 4.

Examples of a virtual reality user device 400 in operation are described below and in FIG. 5. The virtual reality user device 400 is configured to identify and authenticate a user 106. The virtual reality user device 400 is configured to use one or more mechanisms such as credentials (e.g. a log-in and password) or biometric signals to identify and authenticate the user 106. For example, the virtual reality user device 400 is configured to receive an input (e.g. credentials and/or biometric signals) from the user 106 and to compare the user's input to verification data that is stored for the user 106 to authenticate the user 106. In one embodiment, the verification data is previously stored credentials or biometric signals for the user 106.

The virtual reality user device 400 is further configured to identify a user token 108 for the user 106 once the user 106 has been authenticated. The user token 108 is a label or descriptor (e.g. a name based on alphanumeric characters) used to uniquely identify the user 106. In one embodiment, the virtual reality user device 400 selects the user token 108 from a plurality of user token 108 based on the identify of the user 106. In other embodiments, the virtual reality user device 400 selects or identifies the user token 108 based on any other criteria for the user 106. The virtual reality user device 400 is configured to send the identified user token 108 to the remote server 102 to request virtual data 120 for the user 106. The virtual data 120 includes, but is not limited to, one or more documents, status tags linked with documents, payment history, transfer options, and payment options for the user 106. Transfer options include, but are not limited to, peer-to-peer transfer options, institution-to-institution transfer options, and payment options. The status tags display the current status of their corresponding documents. A status tag may indicate the current status of a document as active, inactive, pending, on hold, paid, unpaid, or any other suitable status to described the current status of the document. In one embodiment, status tags are metadata that is added to a document or file. In another embodiment, status tags are separate files that are each linked with or reference a document or file.

The virtual reality user device 106 is configured to receive virtual data 120 from the server 102 in response to sending the user token 108. The virtual reality user device 400 is configured to process the virtual data 120 to identify one or more documents, status tags linked with documents, payment history, transfer options, payment options, and/or any other information provided for the user 106.

The virtual reality user device 400 is configured to present the one or more documents as virtual objects in a virtual reality environment 200. The virtual reality environment 200 is a virtual room, a virtual home, a virtual office, or any other suitable virtual environment. For example, the virtual reality environment 200 is configured to simulate a home office with a virtual desk and virtual office supplies. The virtual reality user device 400 is further configured to overlay status tags with their corresponding documents in the virtual reality environment 200.

The virtual reality user device 400 is also configured to present other information for the user 106 including, but not limited to, payment history, transfer options, and payment options available for the user 106. For example, the virtual reality user device 400 overlays virtual objects with payment information linked with the user 106 and one or more of the documents in the virtual reality environment 200 when the virtual data 120 includes paid documents. As another example, the virtual reality user device 400 overlays virtual objects with the one or more transfer options (e.g. payment options) linked with the user 106 in the virtual reality environment 200 when the virtual data 120 includes unpaid documents.

The virtual reality user device 400 is configured to identify a selected payment option by the user 106 when the virtual reality user device 400 presents one or more payment options. The virtual reality user device 400 receives an indication of the selected payment option from the user 106 as a voice command, a gesture, an interaction with a button on the virtual reality user device 400, or in any other suitable form. The virtual reality user device 400 is configured to send a message 124 identifying the selected payment option to the remote server 102 to initiate a payment associated with the document (e.g. when the document is an invoice or the like) using the selected payment option.

In one embodiment, the virtual reality user device 400 is configured to obtain payment information from the user 106 that is different than the one or more payment options presented to the user 106. For example, the user 106 may use a physical card (e.g. a gift card, credit card, or debit card) or physical check to make a payment. The virtual reality user device 400 is configured to use optical character recognition to obtain text information from the card or check and to use the text information as payment information. The virtual reality user device 400 is configured to send a message 124 comprising the payment information to the remote server 102 to initiate a payment of the document using the provided payment information.

The network 104 comprises a plurality of network nodes configured to communicate data between the virtual reality user device 400 and one or more servers 102 and/or third-party databases 118. Examples of network nodes include, but are not limited to, routers, switches, modems, web clients, and web servers. The network 104 is configured to communicate data (e.g. user tokens 108 and virtual data 120) between the virtual reality user device 400 and the server 102. Network 104 is any suitable type of wireless and/or wired network including, but not limited to, all or a portion of the Internet, the public switched telephone network, a cellular network, and a satellite network. The network 104 is configured to support any suitable communication protocols as would be appreciated by one of ordinary skill in the art upon viewing this disclosure.

The server 102 is linked to or associated with one or more institutions. Examples of institutions include, but are not limited to, organizations, businesses, government agencies, financial institutions, and universities, among other examples. The server 102 is a network device comprising one or more processors 110 operably coupled to a memory 112. The one or more processors 110 are implemented as one or more central processing unit (CPU) chips, logic units, cores (e.g. a multi-core processor), field-programmable gate array (FPGAs), application specific integrated circuits (ASICs), or digital signal processors (DSPs). The one or more processors 110 are communicatively coupled to and in signal communication with the memory 112. The one or more processors 110 are configured to process data and may be implemented in hardware or software. The one or more processors 110 are configured to implement various instructions. For example, the one or more processors 110 are configured to implement a transfer management engine 114. In an embodiment, the transfer management engine 114 is implemented using logic units, FPGAs, ASICs, DSPs, or any other suitable hardware.

Examples of the transfer management engine 114 in operation are described in detail below and in FIG. 6. In one embodiment, the transfer management engine 114 is configured to receive user tokens 108 and to process user tokens 108 to identify a user 106. In one embodiment, processing the user token 108 comprises decrypting and/or decoding the user token 108 when the user token 108 is encrypted or encoded by the virtual reality user device 400. The transfer management engine 114 employs any suitable decryption or decoding technique as would be appreciated by one of ordinary skill in the art. The transfer management engine 114 is configured to use the user token 108 to look-up and identify account information for the user 106 in an account information database 115. Account information includes, but is not limited to, electronic documents (e.g. account information, statements, and invoices), institution names, account names, account balances, account types, payment history, user credentials for other databases, and/or any other information linked with a user 106.

In one embodiment, the transfer management engine 114 is configured to identify one or more documents for the user 106 based on the user token 108. The transfer management engine 114 is further configured to use the account information to determine the status of the documents, for example, whether the documents have been paid. For example, the transfer management engine 114 is configured to first use the user token 108 to locate payment history for the user 106 and then searches the payment history for transactions that corresponds with the documents. In this example, the transfer management engine 114 determines that the status of a document as paid when a transaction is found for the document. The transfer management engine 114 determines the status of a document as unpaid when a transaction is not found for the document.

The transfer management engine 114 is configured to generate and/or link status tags with each of the one or more documents for the user 106 based on the current status of the documents. The status tag indicates the current status of a document as active, inactive, pending, on hold, paid, unpaid, current, old, expired, deposited, not shipped, shipped, in transit, delivered, unredeemed, redeemed, a balance amount, or any other suitable status to described the current status of the document. The transfer management engine 114 is configured to generate virtual data 120 for the user 106 that comprises the one or more documents and the status tags linked with the documents. Virtual data 120 may further comprise, transfer options, payment options, payment scheduling information, account information, or any other suitable information related to the user 160 and/or the documents. The transfer management engine 114 is configured to send the virtual data 120 to the virtual reality user device 400 to be presented to the user 106.

The transfer management engine 114 is further configured to receive a message 124 from the virtual reality user device 400 that identifies a selected payment option from the user 106. For example, the selected payment option identifies a checking account, a savings account, a credit card, or any other payment account for the user 106. The transfer management engine 114 is configured to facilitate a payment of one or more of the documents on behalf of the user 106 using the selected payment option.

The transfer management engine 114 is further configured to send updated virtual data 120 to the virtual reality user device 400 that comprises an updated status tags for one or more of the documents previously sent to the use 106. For example, the transfer management engine 114 is configured to send virtual data 120 with a status tag that identifies a document as paid when the transfer management engine 114 makes a payment on the document.

The memory 112 comprises one or more disks, tape drives, or solid-state drives, and may be used as an over-flow data storage device, to store programs when such programs are selected for execution, and to store instructions and data that are read during program execution. The memory 112 may be volatile or non-volatile and may comprise read-only memory (ROM), random-access memory (RAM), ternary content-addressable memory (TCAM), dynamic random-access memory (DRAM), and static random-access memory (SRAM). The memory 112 is operable to store an account information database 115, transfer management instructions 116, and/or any other data or instructions. The transfer management instructions 116 comprise any suitable set of instructions, logic, rules, or code operable to execute the transfer management engine 114. The account information database 115 comprises account information that includes, but is not limited to, electronic documents (e.g. account information, statements, and invoices), institution names, account names, account balances, account types, and payment history. In an embodiment, the account information database 115 is stored in a memory external of the server 102. For example, the server 102 is operably coupled to a remote database storing the account information database 115.

In one embodiment, the server 102 is in signal communication with one or more third-party databases 118. Third-party databases 118 are databases owned or managed by a third-party source. Examples of third-party sources include, but are not limited to, vendors, institutions, and businesses. In one embodiment, the third-party databases 118 comprise account information and payment history for the user 106. In one embodiment, third-party databases 118 are configured to push (i.e. send) data to the server 102. The third-party database 118 is configured to send information (e.g. payment history information) for a user 106 to the server 102 with or without receiving a data request for the information. The third-party database 118 is configured to send the data periodically to the server 102, for example, hourly, daily, or weekly. For example, the third-party database 118 is associated with a vendor and is configured to push payment history information linked with the user 106 to the server 102 hourly. The payment history information comprises transaction history information linked with the use 106. In another example, the third-party database 118 is associated with a mail courier and is configured to push shipping information linked with the user 106 to the server 102 daily. The shipping information comprises tracking information linked with the user 106.

In another embodiment, a third-party database 118 is configured to receive a data request 122 for information linked with the user 106 from the server 102 and to send the requested information back to the server 102. For example, a third-party database 118 is configured to receive a user token 108 for the user 106 in the data request 122 and uses the user token 108 to look-up payment history information for the user 106 within the records of the third-party database 118. In other examples, third-party databases 118 are configured to use any information provided to the server 102 to look-up information related to the user 106.

In one embodiment, the virtual reality user device 400 is configured to send a user token 108 or a data request 122 to the third-party database 118. In other words, the virtual reality user device 400 sends the user token 108 or data request 122 directly to the third-party database 118 for information linked with the user 112 instead of to the server 102. The third-party databases 118 are configured to receive a user token 108 or a data request 122 for information linked with the user 112 from the virtual reality user device 400 and to send the requested information back to the virtual reality user device 400.

The following is a non-limiting example of how the virtual reality system 100 may operate. In this example, a user 106 is sitting at their desk wearing the virtual reality user device 400. The user 106 authenticates themselves before using the virtual reality user device 400 by providing credentials (e.g. a log-in and password) and/or a biometric signal.

The virtual reality user device 400 authenticates user 106 by comparing the user's input to verification data (e.g. a biometric signal) stored for the user 106. When the user's input matches or is substantially the same as the verification data stored for the user, the virtual reality user device 400 is able to identify and authenticate the user 106. When the user's input does not match the verification data stored for the user 106, the virtual reality user device 400 is unable to identify and authenticate the user 106. The virtual reality user device 400 identifies a user token 108 for the user 106 based on the identity of the user 106 and in response to authenticating the user 106. Once the user 106 has been authenticated, the user token 108 is used by other systems and devices to identify and authenticate the user 106 without requiring the user 106 to provide additional credentials for each system. The virtual reality user device 400 sends the user token 108 to the remote server 102. In one embodiment, the virtual reality user device 400 encrypts and/or encodes the user token 108 prior to sending the user token 108 to the remote server 102.

The server 102 receives the user token 108 and processes the user token 108 to identify the user 106. The server 102 decrypts or decodes the user token 108 when the user token 108 is encrypted or encoded by the virtual reality user device 400. The server 102 uses the user token 108 to look-up account information for the user 106 in the account information database 115. For example, the server 102 identifies one or more documents, a payment history, and available transfer options (e.g. payment options) for the user 106 based on the user's 106 account information. The server 102 uses the payment history for the user 106 to determine whether the user 106 has already paid any of the documents. For instance, the server 102 searches the payment history for any transactions made by the user 106 that corresponds with the text information in the documents.

In one embodiment, the server 102 sends a data request 122 to one or more third-party databases 118 to look for information linked with the user 106. For example, the server 102 sends a data request 122 comprising the user token 108 to identify and authenticate the user 106. In another example, the server 102 uses the user token 108 to look-up credentials for the user 106 in the account information database 115. The server 102 sends the identified credentials in the data request 122 to identify and authenticate the user 106. The server 102 sends the data request 122 to a business identified as the source of a document to request information. When the server 102 receives the information from the third-party database 118, the server 102 determines the status of the document based on the received information. For example, the server 102 determines whether the user 106 has already paid the document based on the received information.

The server 102 determines the current status of the one or more documents and links status tags with each of the documents based on the current status of the document. In one embodiment, the status tag identifies the document as paid when the server 102 determines that the user 106 has already paid the document. The status tag identifies the document as unpaid when the server 102 determines that the user 112 has not paid the document 108 yet.

The server 102 generates virtual data 120 that comprises information associated with the one or more documents and the status tags linked with the one or more documents. The virtual data 120 further comprises the one or more payment options that are available to the user 106 based on the user's 106 account information when there are unpaid documents in the virtual data 120. The one or more payment options each identify a payment account for the user 106. In some embodiments, the virtual data 120 further comprises suggested payment dates for each of the payment options and/or recommendations for which payment account the user 106 should use. The server 102 then sends the virtual data 120 to the virtual reality user device 400.

The virtual reality user device 400 receives the virtual data 120 and processes the virtual data 120 to identify the one or more documents, status tags linked with the documents, one or more payment options for the user 106, and/or any other information. The virtual reality user device 400 presents the one or more documents to the user 106 as virtual objects in a virtual reality environment 200. For example, the virtual reality user device 400 displays the one or more documents on a virtual desk in a virtual office. The virtual reality user device 400 determines whether there are any paid documents in the virtual data 120 and overlays status tags for the paid documents with their corresponding documents in the virtual reality environment 200. The status tags identify the documents as paid. In one embodiment, the virtual reality user device 400 presents the status tags as virtual objects overlaid onto their corresponding documents in the virtual reality environment 200. In another embodiment, the virtual reality user device 400 presents the status tags as virtual objects adjacent to their corresponding documents in the virtual reality environment 200. The virtual reality user device 400 also determines whether there any unpaid documents in the virtual data 120 and overlays status tags for the unpaid documents with their corresponding documents in the virtual reality environment 200. The status tags identify the documents as not paid. Overlaying the status tags with their corresponding documents allows the user 106 to readily see the status of each of the documents.

The virtual reality user device 400 also presents other information such as payment history and payment options available to the user 106 as virtual objects in the virtual reality environment 200. For example, the virtual reality user device 400 overlays virtual objects with payment information linked with the user 106 and one or more of the documents in the virtual reality environment 200 when the virtual data 120 includes paid documents. As another example, the virtual reality user device 400 overlays virtual objects with the one or more payment options linked with the user 106 in the virtual reality environment 200 when the virtual data 120 includes unpaid documents.

When the virtual reality user device 400 presents the one or more payment options, the virtual reality user device 400 identifies a selected payment option indicated by the user 106. The virtual reality user device 400 receives the indication of the selected payment option from the user 106 as a voice command, a gesture, an interaction with a button on the virtual reality user device 400, or in any other suitable form. The virtual reality user device 400 is configured to send a message 124 identifying the selected payment option for one or more of the documents to the remote server 102.

The server 102 receives the message 124 identifying the selected payment option and facilitates a payment of the one or more documents using the selected payment option for the user 106. For example, when the message 124 indicates the user's 106 checking account, the server 102 facilitates a payment of a document using the user's 106 checking account. In one embodiment, the server 102 sends updated virtual data 120 to the virtual reality user device 400 that comprises status tags identifying the documents as paid.

FIGS. 2 and 3 are examples of a virtual reality user device 400 presenting different virtual objects in a virtual reality environment 200. The virtual objects are based on the account information for the user 106 using the virtual reality user device 400. FIG. 2 is an embodiment of a first person view from a display 408 of a virtual reality user device 400 presenting virtual objects 202 within a virtual reality environment 200. The virtual reality environment 200 is only visible the person using a virtual reality user device 400. Other people around the user are unable to see the content being displayed to the user.

In FIG. 2, a user 106 is sitting at their desk using the virtual reality user device 400. The user 106 does not need to have any physical documents in front of the user 106 to review the status of different documents. In other examples, the user 106 may be in any other location using the virtual reality user device 400. For example, the user 106 may use the virtual reality user device 400 is a public park, the library, on a train, in the car, at a bookstore, a coffee shop, or any other location. The virtual reality user device 400 only displays to the user 106 and other people around the user 106 are unable to see the content that is being presented to the user 106. Since only the user 106 is able to see the content presented by the virtual reality user device 400, the user 106 is able to privately and securely view documents 210 and information linked with the documents 210 and/or user 106 in any location.

In FIG. 2, the virtual reality environment 200 is a virtual home office with a virtual desk 206 and virtual office supplies 208. In a virtual reality environment 200 the user 106 is able to move, organize, and manipulate virtual objects 202 within the virtual reality environment 200. For example, the user 106 is able to move virtual office supplies 208 around on the virtual desk 206. As another example, the user 106 is able to stack and file away documents within the virtual reality environment 200, for example, in a virtual filing cabinet or folder.

The virtual reality user device 400 allows to the user 106 to authenticate themselves and to generate a user token 108 that is used to request documents 210 and information linked with the documents 210. The user token 108 allows the virtual reality user device 400 to make fewer data requests (e.g. a single data request) for documents 210 and information linked with the documents 210, for example status tags, regardless of the number of sources used to compile the information linked the document 210. Using fewer request improves the efficiency of the system compared to other systems that make individual request to each source for information. Additionally, the virtual reality user device 400 is able to request documents 210 and information linked with documents 210 without knowledge of which sources and how many sources need to be queried.

In response to sending the user token 108, the virtual reality user device 400 receives virtual data 120 comprising a document 210 and information linked with the document 210. The virtual reality user device 400 presents the user 106 with the document 210 that was obtained based on a user token 108 linked with the user 106. Examples of documents include, but are not limited to, articles, newspapers, books, magazines, account information, statements, invoices, checks, shipping receipts, gift certificates, coupons, rebates, warranties, or any other type of document. In one embodiment, the user 106 indicates which types of documents the user 106 is interested in viewing. In this example, the virtual reality user device 400 receives virtual data 120 comprising an invoice as document 210 and presents the invoice to the user 106. In other examples, the virtual data 120 comprises any other types of documents 210.

In FIG. 2, the information linked with the document 210 is a status tag 212 and payment history 214 for the document 210. The virtual reality user device 400 overlays the status tag 212 with the document 210. In this example, the status tag 212 is displaying the current status of the document as paid. However, the status tag 212 could provide information identifying any suitable status of the document 210. In other examples, the status tag 212 is overlaid adjacent to the document 210 and/or any other virtual objects 202. The status tag 212 allows the user 106 to quickly determine the status of the document 210 and any other information linked with the document 210. In some embodiments, documents 210 are presented to the user 106 without a status tag 212. For example, a document 210 is presented to the user 106 without a status tag 212 when the current status of the document cannot be determined.

In this example, the virtual reality user device 400 also overlays the payment history 214 linked with the document 210 and the user 106. The payment history 214 may comprise information related to a transaction linked with the document 210. For example, the payment history 214 may comprise a transaction timestamp, account information, a payment account used for the transaction, and/or any other information, or combinations thereof. In other examples, the virtual reality user device 400 presents any other information linked with the document 210 and/or the user 106.

FIG. 3 is another embodiment of a first person view from a display 408 of a virtual reality user device 400 presenting virtual objects 202 within a virtual reality environment 200. Similar to FIG. 2, the user 106 is sitting at their desk using the virtual reality user device 400. The user 106 does not need to have any physical documents in front of the user 106 to review the status of different documents. The virtual reality user device 400 authenticates the user 106 and sends a user token 108 to request documents 210 and information linked with the documents 210 from a remote server 102. In response to sending the user token 108, the virtual reality user device 400 receives virtual data 120 comprising a document 210 and information linked with the document 210. In this example, the virtual reality user device 400 receives virtual data 120 comprising an invoice as a document 210 and presents the invoice to the user 106. In other examples, the virtual data 120 comprises any other types of documents 210.

In FIG. 3, the information linked with the document 210 is a status tag 212 and payment options 216 for the document 210. The virtual reality user device 400 overlays the status tag 212 with the document 210. In this example, the status tag 212 identifies the document 210 as not paid. The virtual reality use device 400 also presents payment options 216 for the document 210 as a virtual object 202 in the virtual reality environment 200. The payment options 216 comprise one or more payment options that are available to the user 106 based on the user's 106 account information. In an embodiment, the payment options 216 comprise recommendations about which payment option 216 the user should use based on their account information. For example, the virtual reality user device 400 recommends using the first account for the user 106, but does not recommend using the second account or third account for the user 106. In other examples, the virtual reality user device 400 also recommends suggest dates for scheduling a payment using the payment options 216. In other examples, the virtual reality user device 400 presents any other information linked with the document 210 and/or the user 106.

In another example, the virtual reality user device 400 receives virtual data 120 comprising a shipping receipt as the document 210 and the information linked with the document 210 is the status of a package linked with the shipping receipt. The virtual reality user device 400 receives a status tag 212 that indicates the status of the package linked with the shipping receipt. The status tag 212 is overlaid onto the shipping receipt in the virtual reality environment 200. The status tag 212 indicates the package status as not yet shipped, shipped, in transit, delivered, or any other suitable status.

In another example, the virtual reality user device 400 receives virtual data 120 comprising a coupon or a voucher as the document 210 and the information linked with the document 210 is the status of the coupon. The virtual reality user device 400 receives a status tag 212 that indicates the status of the coupon. The status tag 212 is overlaid onto the coupon in the virtual reality user device 400. The status tag 212 indicates whether the coupon is unused, used, expired, or any other suitable status.

In another example, the virtual reality user device 400 receives virtual data 120 comprising a check as the document 210 and the information linked with the document 210 is the status of the check. For example, the check is a check the user 106 previously attempted to deposit at an automated teller machine (ATM) or using an application on a mobile device. The virtual reality user device 400 receives a status tag 212 that indicates the status of the check. The status tag 212 is overlaid onto the check in the virtual environment 200. The status tag 212 indicates the check status as pending, deposited, or any other suitable status.

In another example, the virtual reality user device 400 receives virtual data 120 comprises a gift card as the document 210 and the information linked with the document 210 is the status (e.g. remaining balance) of the gift card. The virtual reality user device 400 receives a status tag 212 that indicates the status of the gift card. The status tag 212 indicates the remaining balance, whether the gift card is expired, or any other suitable status.

FIG. 4 is a schematic diagram of an embodiment of a virtual reality user device 400 employed by the virtual reality system 100. The virtual reality user device 400 is configured to authenticate a user 106, to identify a user token 108 for the user 106, to send the user token 108 to a remote server 102, to receive virtual data 120 for the user 106 in response to sending the user token 108, and to present the virtual data 120 as virtual objects in a virtual reality environment 200. An example of the virtual reality user device 400 in operation is described in FIG. 5.

The virtual reality user device 400 comprises a processor 402, a memory 404, a camera 406, a display 408, a wireless communication interface 410, a network interface 412, a microphone 414, a global position system (GPS) sensor 416, and one or more biometric devices 418. The virtual reality user device 400 may be configured as shown or in any other suitable configuration. For example, virtual reality user device 400 may comprise one or more additional components and/or one or more shown components may be omitted.

Examples of the camera 406 include, but are not limited to, charge-coupled device (CCD) cameras and complementary metal-oxide semiconductor (CMOS) cameras. The camera 406 is configured to capture images of people, text, and objects within a real environment. The camera 406 is configured to capture images continuously, at predetermined intervals, or on-demand. For example, the camera 406 is configured to receive a command from a user to capture an image. In another example, the camera 406 is configured to continuously capture images to form a video stream of images. The camera 406 is operable coupled to an optical character (OCR) recognition engine 424 and/or the gesture recognition engine 426 and provides images to the OCR recognition engine 424 and/or the gesture recognition engine 426 for processing, for example, to identify gestures, text, and/or objects in front of the user 106.

The display 408 is configured to present visual information to a user 106 using virtual or graphical objects in an virtual reality environment 200 in real-time. In an embodiment, the display 408 is a wearable optical head-mounted display configured to reflect projected images for the user 106 to see. In another embodiment, the display 408 is a wearable head-mounted device comprising one or more graphical display units integrated with the structure of the wear head-mounted device. Examples of configurations for graphical display units include, but are not limited to, a single graphical display unit, a single graphical display unit with a split screen configuration, and a pair of graphical display units. The display 408 may comprise graphical display units, lens, semi-transparent mirrors embedded in an eye glass structure, a visor structure, or a helmet structure. Examples of display units include, but are not limited to, a cathode ray tube (CRT) display, a liquid crystal display (LCD), a liquid crystal on silicon (LCOS) display, a light emitting diode (LED) display, an active matric OLED (AMOLED), an organic LED (OLED) display, a projector display, or any other suitable type of display as would be appreciated by one of ordinary skill in the art upon viewing this disclosure. In another embodiment, the graphical display unit is a graphical display on a user device. For example, the graphical display unit may be the display of a tablet or smart phone configured to display virtual or graphical objects in a virtual reality environment 200 in real-time.

Examples of the wireless communication interface 410 include, but are not limited to, a Bluetooth interface, a radio frequency identifier (RFID) interface, a near-field communication (NFC) interface, a local area network (LAN) interface, a personal area network (PAN) interface, a wide area network (WAN) interface, a Wi-Fi interface, a ZigBee interface, or any other suitable wireless communication interface as would be appreciated by one of ordinary skill in the art upon viewing this disclosure. The wireless communication interface 410 is configured to allow the processor 402 to communicate with other devices. For example, the wireless communication interface 410 is configured to allow the processor 402 to send and receive signals with other devices for the user 106 (e.g. a mobile phone) and/or with devices for other people. The wireless communication interface 410 is configured to employ any suitable communication protocol.

The network interface 412 is configured to enable wired and/or wireless communications and to communicate data through a network, system, and/or domain. For example, the network interface 412 is configured for communication with a modem, a switch, a router, a bridge, a server, or a client. The processor 402 is configured to receive data using network interface 412 from a network or a remote source.

Microphone 414 is configured to capture audio signals (e.g. voice commands) from a user and/or other people near the user 106. The microphone 414 is configured to capture audio signals continuously, at predetermined intervals, or on-demand. The microphone 414 is operably coupled to the voice recognition engine 422 and provides captured audio signals to the voice recognition engine 422 for processing, for example, to identify a voice command from the user 106.

The GPS sensor 416 is configured to capture and to provide geographical location information. For example, the GPS sensor 416 is configured to provide the geographic location of a user 106 employing the virtual reality user device 400. The GPS sensor 416 is configured to provide the geographic location information as a relative geographic location or an absolute geographic location. The GPS sensor 416 provides the geographic location information using geographic coordinates (i.e. longitude and latitude) or any other suitable coordinate system.

Examples of biometric devices 418 include, but are not limited to, retina scanners and finger print scanners. Biometric devices 418 are configured to capture information about a person's physical characteristics and to output a biometric signal 431 based on captured information. A biometric signal 431 is a signal that is uniquely linked to a person based on their physical characteristics. For example, a biometric device 418 may be configured to perform a retinal scan of the user's eye and to generate a biometric signal 431 for the user 106 based on the retinal scan. As another example, a biometric device 418 is configured to perform a fingerprint scan of the user's finger and to generate a biometric signal 431 for the user 106 based on the fingerprint scan. The biometric signal 431 is used by a biometric engine 430 to identify and/or authenticate a person.

The processor 402 is implemented as one or more CPU chips, logic units, cores (e.g. a multi-core processor), FPGAs, ASICs, or DSPs. The processor 402 is communicatively coupled to and in signal communication with the memory 404, the camera 406, the display 408, the wireless communication interface 410, the network interface 412, the microphone 414, the GPS sensor 416, and the biometric devices 418. The processor 402 is configured to receive and transmit electrical signals among one or more of the memory 404, the camera 406, the display 408, the wireless communication interface 410, the network interface 412, the microphone 414, the GPS sensor 416, and the biometric devices 418. The electrical signals are used to send and receive data (e.g. user tokens 108 and virtual data 120) and/or to control or communicate with other devices. For example, the processor 402 transmit electrical signals to operate the camera 406. The processor 402 may be operably coupled to one or more other devices (not shown).

The processor 402 is configured to process data and may be implemented in hardware or software. The processor 402 is configured to implement various instructions. For example, the processor 402 is configured to implement a virtual overlay engine 420, a voice recognition engine 422, an OCR recognition engine 424, a gesture recognition engine 426, an electronic transfer engine 428, and a biometric engine 430. In an embodiment, the virtual overlay engine 420, the voice recognition engine 422, the OCR recognition engine 424, the gesture recognition engine 426, the electronic transfer engine 428, and the biometric engine 430 are implemented using logic units, FPGAs, ASICs, DSPs, or any other suitable hardware.

The virtual overlay engine 420 is configured to present and overlay virtual objects in a virtual reality environment 200 using the display 408. For example, the display 408 may be head-mounted display that allows a user to view virtual objects such as documents and status tags. The virtual overlay engine 420 is configured to process data to be presented to a user as virtual objects on the display 408. Examples of presenting virtual objects in a virtual reality environment 200 are shown in FIGS. 2 and 3.

The voice recognition engine 422 is configured to capture and/or identify voice patterns using the microphone 414. For example, the voice recognition engine 422 is configured to capture a voice signal from a person and to compare the captured voice signal to known voice patterns or commands to identify the person and/or commands provided by the person. For instance, the voice recognition engine 422 is configured to receive a voice signal to authenticate a user 106 and/or to identify a selected option or an action indicated by the user.

The OCR recognition engine 424 is configured to identify objects, object features, text, and/or logos using images 407 or video streams created from a series of images 407. In one embodiment, the OCR recognition engine 424 is configured to identify objects and/or text within an image captured by the camera 406. In another embodiment, the OCR recognition engine 424 is configured to identify objects and/or text in about real-time on a video stream captured by the camera 406 when the camera 406 is configured to continuously capture images. The OCR recognition engine 424 employs any suitable technique for implementing object and/or text recognition as would be appreciated by one of ordinary skill in the art upon viewing this disclosure.

The gesture recognition engine 426 is configured to identify gestures performed by a user 106 and/or other people. Examples of gestures include, but are not limited to, hand movements, hand positions, finger movements, head movements, and/or any other actions that provide a visual signal from a person. For example, gesture recognition engine 426 is configured to identify hand gestures provided by a user 106 to indicate various commands such as a command to initiate a request for virtual data 120 for the user 106. The gesture recognition engine 426 employs any suitable technique for implementing gesture recognition as would be appreciated by one of ordinary skill in the art upon viewing this disclosure.

The electronic transfer engine 428 is configured to identify a user token 108 that identifies the user 106 upon authenticating the user 106. The electronic transfer engine 428 is configured to send the user token 108 to a remote server 102 as a data request to initiate the process of obtaining information linked with the user 106. The electronic transfer engine 428 is further configured to provide the information (e.g. virtual data 120) received from the remote server 102 to the virtual overlay engine 420 to present the information as one or more virtual objects in a virtual reality environment 200. An example of employing the electronic transfer engine 428 to request information and presenting the information to a user is described in FIG. 5.

In an embodiment, the electronic transfer engine 428 is configured to encrypt and/or encode the user token 108. Encrypting and encoding the user token 108 obfuscates and masks information being communicated by the user token 108. Masking the information being communicated protects users and their information in the event of unauthorized access to the network and/or data occurs. The electronic transfer engine 428 employs any suitable encryption or encoding technique as would be appreciated by one of ordinary skill in the art.

In an embodiment, the electronic transfer engine 428 is further configured to present one or more transfer options that are linked with the user 106. For example, the electronic transfer engine 428 presents one or more payment options that are linked with the user 106. The electronic transfer engine 428 is configured to identify a selected payment option and to send a message 124 to the remote server 102 that identifies the selected payment option. The user 106 identifies a selected payment option by giving a voice command, performing a gesture, interacting with a physical component (e.g. a button, knob, or slider) of the virtual reality user device 400, or any other suitable mechanism as would be appreciated by one of ordinary skill in the art. An example of employing the electronic transfer engine 428 to identify a selected payment option and to send a message 124 to the remote server 102 that identifies the selected payment option is described in FIG. 5.

The biometric engine 430 is configured to identify a person based on a biometric signal 431 generated from the person's physical characteristics. The biometric engine 430 employs one or more biometric devices 418 to identify a user 106 based on one or more biometric signals 431. For example, the biometric engine 430 receives a biometric signal 431 from the biometric device 418 in response to a retinal scan of the user's eye and/or a fingerprint scan of the user's finger. The biometric engine 430 compares biometric signals 431 from the biometric device 418 to verification data 407 (e.g. previously stored biometric signals 431) for the user to authenticate the user. The biometric engine 430 authenticates the user when the biometric signals 431 from the biometric devices 418 substantially matches (e.g. is the same as) the verification data 407 for the user.

The memory 404 comprise one or more disks, tape drives, or solid-state drives, and may be used as an over-flow data storage device, to store programs when such programs are selected for execution, and to store instructions and data that are read during program execution. The memory 404 may be volatile or non-volatile and may comprise ROM, RAM, TCAM, DRAM, and SRAM. The memory 404 is operable to store images, user tokens 108, biometric signals 431, verification data 407, virtual overlay instructions 432, voice recognition instructions 434, OCR recognition instructions 436, gesture recognition instructions 438, electronic transfer instructions 440, biometric instructions 442, and any other data or instructions.

Images comprises images captured by the camera 406 and images from other sources. In one embodiment, images comprises images used by the virtual reality user device 400 when performing optical character recognition. Images can be captured using camera 406 or downloaded from another source such as a flash memory device or a remote server via an Internet connection.

Verification data 407 comprises any suitable information for identify and authenticating a virtual reality user device 400 user 106. In an embodiment, verification data 407 comprise previously stored credential and/or biometric signals 431 stored for users. Verification data 407 is compared to an input provided by a user 106 to determine the identity of the user 106. When the user's input matches or is substantially the same as the verification data 407 stored for the user 106, the virtual reality user device 400 is able to identify and authenticate the user 106. When the user's input does not match the verification data 407 stored for the user 106, the virtual reality user device 400 is unable to identify and authenticate the user 106.

Biometric signals 431 are signals or data that is generated by a biometric device 418 based on a person's physical characteristics. Biometric signals 431 are used by the virtual reality user device 400 to identify and/or authenticate a virtual reality user device 400 user 106 by comparing biometric signals 431 captured by the biometric devices 418 with previously stored biometric signals 431.

User tokens 108 are generated or identified by the electronic transfer engine 428 and sent to a remote server 102 to initiate a process for obtaining information linked with the user. In one embodiment, the user tokens 108 is a message or data request comprising any suitable information for requesting information from the remote server 102 and/or one or more other sources (e.g. third-party databases 118). For example, the user token 108 may comprise information identifying a user 106. An example of the virtual reality user device 400 identifying a user token 108 to initiate a process for obtaining information linked with the user is described in FIG. 5.

The virtual overlay instructions 432, the voice recognition instructions 434, the OCR recognition instructions 436, the gesture recognition instructions 438, the electronic transfer instructions 440, and the biometric instructions 442 each comprise any suitable set of instructions, logic, rules, or code operable to execute the virtual overlay engine 420, the voice recognition engine 422, the OCR recognition engine 424, the gesture recognition engine 426, the electronic transfer engine 428, and the biometric engine 430, respectively.

FIG. 5 is a flowchart of an embodiment of a virtual reality overlaying method 500. Method 500 is employed by the processor 402 of the virtual reality user device 400 to authenticate a user and to identify a user token 108 for the user. The virtual reality user device 400 uses the user token 108 to obtain information linked with the user and to present the information to the user as virtual objects in a virtual reality environment 200.

At step 502, the virtual reality user device 400 authenticates the user. The user provides credentials (e.g. a log-in and password) or a biometric signal to authenticate themselves. The virtual reality user device 400 authenticates the user based on the user's input. For example, the virtual reality user device 400 compares the user's input to verification data 407 stored for the user. When the user's input matches or is substantially the same as the verification data 407 stored for the user, the virtual reality user device 400 identifies and authenticates the user. When the user's input does not match the verification data 407 stored for the user, the virtual reality user device 400 is unable to identify and authenticate the user 106. In one embodiment, the virtual reality user device 400 reattempts to authenticate the user by asking the user to resubmit their input.

At step 504, the virtual reality user device 400 identifies a user token 108 for the user. In one embodiment, the virtual reality user device looks up the user token 108 for the user based on the identity of the user. For example, once the user has been authenticated, the virtual reality user device 400 is able to identify the user and uses the user's identity (e.g. name) to look up the user token 108 for the user. In another embodiment, once the user has been authenticated, the virtual reality user device 400 generates a user token 108 for the user based on the identity of the user. In one embodiment, the virtual reality user device 400 encrypts and/or encodes the user token 108 prior to sending the user token 108. Encrypting and/or encoding the user token 108 protects the user 106 and their information in the event of unauthorized access to the network and/or data occurs. At step 506, the virtual reality user device 400 sends the user token 108 to a remote server 102.

The user token 108 is used to request documents linked with the user 106 and information linked with the documents such as status tags. The status tag allows the virtual reality user device 400 to send fewer data requests for the documents and information linked with the documents regardless of the number of sources containing the documents and information linked with the documents. Using fewer data requests reduces the amount of data being sent and reduces the time that network resources are occupied compared to other systems that use multiple requests by sending individual requests to each source. The virtual reality user device 400 is able to request documents and information linked with the documents without knowledge of which sources or how many sources need to be queried for information linked with the user 106 and the documents.

At step 508, the virtual reality user device 400 receives virtual data 120 for the user in response to sending the user token 108. The virtual data 120 comprises one or more documents, status tags linked with the one or more documents, and transfer options (e.g. payment options) linked with the user. The status tag may indicate the current status of the documents as active, inactive, pending, on hold, paid, unpaid, current, old, expired, deposited, not shipped, shipped, in transit, delivered, unredeemed, a balance amount, or any other suitable status to described the current status of the documents.

In this example, the virtual reality user device 400 receives one or more invoices as documents. At step 510, the virtual reality user device 400 determines whether the virtual data 120 comprises any paid documents. In one embodiment, the virtual reality user device 400 determines whether any of the documents have been paid based on the status tags linked with the documents. For example, the virtual reality user device 400 determines a document has been paid when the status tag linked with the document identifies the document as paid.

In another embodiment, the virtual reality user device 400 determines whether any of the documents have been paid based on payment history provided in the virtual data 120. For example, the virtual reality user device 400 determines a document has been paid when the virtual reality user device 400 locates a transaction in the payment history for the document. In other embodiment, the virtual reality user device 400 may employ any other suitable technique for determining whether any of the documents have been paid.

The virtual reality user device 400 proceeds to step 512 when the virtual reality user device 400 determines that the virtual data 120 comprises a paid document. Otherwise, the virtual reality user device 400 proceeds to step 514 when the virtual reality user device 400 determines that the virtual data 120 does not comprise any paid documents.

At step 512, the virtual reality user device 400 presents documents with a paid status in a virtual reality environment 200. In one embodiment, the virtual reality user device 400 first presents all of the documents in the virtual reality environment 200 without any status tags. When the user indicates that they want to see the documents with the paid status, the virtual reality user device 400 overlays status tags identifying paid documents with their corresponding documents. In this example, the user is able to see initially see the documents without their status tags. In another embodiment, the virtual reality user device 400 presents documents with a paid status in the virtual reality environment 200 with their corresponding status tags.

At step 514, the virtual reality user device 400 determines whether the virtual data 120 comprises any unpaid documents. In one embodiment, the virtual reality user device 400 determines whether any of the documents have been not paid based on the status tags linked with the documents. For example, the virtual reality user device 400 determines a document has not been paid when the status tag linked with the document identifies the document as unpaid.

In another embodiment, the virtual reality user device 400 determines whether any of the documents have not been paid based on payment history provided in the virtual data 120. For example, the virtual reality user device 400 determines a document has not been paid when the virtual reality user device 400 is unable to locate a transaction in the payment history for the document.

In another embodiment, the virtual reality user device 400 determines whether any of the documents have not been paid based on the presence of one or more payment options linked with the document in the virtual data 120. In other embodiment, the virtual reality user device 400 may employ any other suitable technique for determining whether there are any unpaid documents.

The virtual reality user device 400 proceeds to step 516 when the virtual reality user device 400 determines that the virtual data 120 comprises a unpaid document. Otherwise, the virtual reality user device 400 may terminate when the virtual reality user device 400 determines that the virtual data 120 does not comprise any unpaid document.

At step 516, the virtual reality user device 400 presents documents with a not paid status in the virtual reality environment 200. The virtual reality user device 400 presents documents with a not paid status in the virtual reality environment 200 with their corresponding status tags.

At step 518, the virtual reality user device 400 presents one or more transfer options that are available to the user in the virtual reality environment 200. The virtual reality user device 400 presents the one or more payment options as a virtual object overlaid with or adjacent to the one or more documents with a not paid status. The one or more payment options identify different payment accounts that are available to the user based on their account information. For example, the one or more payment accounts identifies a checking account, a savings account, a credit card, or any other payment account for the user.

At step 520, the virtual reality user device 400 identifies a selected transfer option from the one or more transfer options. The virtual reality user device 400 may receive the indication of the selected payment option from the user as a voice command, a gesture, an interaction with a button on the virtual reality user device 400, or in any other suitable form. For example, the user performs a hand gesture to select a payment option and the virtual reality user device 400 identifies the gesture and selected payment option using gesture recognition. In another example, the user gives a voice command to select the payment option and the virtual reality user device 400 identifies the voice command and the selected payment option using voice recognition. At step 522, the virtual reality user device 400 sends a message 124 identifying the selected transfer option to the remote server 102.

FIG. 6 is a flowchart of another embodiment of a virtual reality overlaying method 600. Method 600 is employed by a transfer management engine 114 of the server 102 to provide virtual data 120 to a virtual reality user device 400.

At step 602, the transfer management engine 114 receives a user token 108 for a user from a virtual reality user device 400. In one embodiment, the transfer management engine 114 decrypts and/or decodes the user token 108 when the user token 108 is encrypted or encoded by the virtual reality user device 400. The transfer management engine 114 processes the user token 108 to identify the user. The transfer management engine 114 may also process the user token 108 to identify any other information associated with the user.

At step 604, the transfer management engine 114 identifies account information for the user based on the user token 108. The transfer management engine 114 uses the user token 108 to look-up information for the user in the account information database 115. The information comprise information linked with the user such as account information, credentials, payment history, and electronic documents. At step 606, the transfer management engine 114 identifies one or more documents for the user based on the account information.

At step 608, the transfer management engine 114 determines whether any of the one or more documents have been paid. For example, the transfer management engine 114 determines whether any of the documents have been paid based on the payment history of the user. The transfer management engine 114 searches the payment history for any transactions made by the user that corresponds with the documents. The transfer management engine 114 proceeds to step 610 when the transfer management engine 114 determines there are paid documents. The transfer management engine 114 determines a document has been paid when a transaction is found for a document in the payment history for the user. Otherwise, the transfer management engine 114 proceeds to step 612 when the transfer management engine 114 determines there are no paid documents.

At step 610, the transfer management engine 114 links the paid documents with status tags that identify the documents as paid. In one embodiment, the transfer management engine 114 generates the status tags as metadata that is combined with the documents. In another embodiment, the status tags are separate files that are each linked to or reference a corresponding document.

At step 612, the transfer management engine 114 determines whether any of the one or more documents are unpaid. The transfer management engine 114 determines a document has not been paid when a transaction is not found for a document in the payment history for the user. The transfer management engine 114 proceeds to step 614 when the transfer management engine 114 determines there are unpaid documents. Otherwise, the transfer management engine 114 proceeds to step 612 when the transfer management engine 114 determines there are no unpaid documents.

At step 614, the transfer management engine 114 links the unpaid documents with status tags that identify the documents as not paid. The transfer management engine 114 links the unpaid documents with status tags similarly as the status tags described in step 610.

At step 616, the transfer management engine 114 determines transfer options for the user based on the account information of the user. The transfer management engine 114 identifies one or more payment options available to user based on their account information. In one embodiment, the payment options may comprise a bank account and a credit card account.

At step 618, the transfer management engine 114 generates virtual data 120 for the user. The virtual data 120 comprises the one or more documents, the status tags linked with the documents, and the one or more payment options available to the user. The virtual data 120 may also comprise any other information linked with the user or the user's account information. At step 620, the transfer management engine 114 sends the virtual data 120 to the virtual reality user device 400.

In one embodiment, the transfer management engine 114 receives a message 124 that identifies a selected payment option from the one or more payment options for the user. For example, the selected payment option identifies one of a checking account, a savings account, a credit card, or any other payment account for the user. The transfer management engine 114 facilitates a payment for the unpaid document using the selected payment option. For example, the transfer management engine 114 information from the document to make a payment to the source of the document for the balance indicated by the document using the selected payment option for the user.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A virtual reality system comprising:
a virtual reality user device for a user comprising:
a display configured to present a virtual reality environment to the user;
a memory operable to store:
verification data used to authenticate one or more users; and
user tokens uniquely identifying each of the one or more users;
one or more processers operably coupled to the display and the memory, and configured to implement:
an electronic transfer engine configured to:
receive a user input identifying the user;
compare the user input to the verification data to authenticate the user;
identify a user token for the user in response to authenticating the user;
send the user token to a remote server, wherein the user token requests virtual data for the user comprising:
a document;
a status tag for the document identifying the current status of the document; and
one or more transfer options;
receive the virtual data for the user in response to sending the user token; and
determine whether the status tag indicates the document is unpaid;
a virtual overlay engine configured to:
present the document in the virtual reality environment;
overlay the status tag onto the document in the virtual reality environment; and
present the one or more transfer options for the document in the virtual reality environment when the status tag indicates the document is unpaid; and
the electronic transfer engine further configured to:
identify a selected transfer option from the one or more transfer options; and
send a message identifying the selected transfer option to the remote server; and
a remote server comprising a transfer management engine configured to:
receive the user token;
identify account information for the user based on the user token;
obtain the document for the user based on the account information;
determine whether the document is unpaid based on the account information;
link the document with the status tag indicating the document is unpaid in response to determining that the document is unpaid;
determine the one or more transfer options for the user based on the account information; and
send the virtual data to the virtual reality user device.

2. The system of claim 1, wherein the one or more transfer options indicate:
a plurality of payment accounts; and
a suggested payment date for each of the plurality of payment accounts.

3. The system of claim 1, wherein identifying account information for the user based on the user identifier comprises requesting at least a portion of the account information from a third-party database.

4. The system of claim 1, wherein:
the user input is a voice command; and
the virtual reality user device comprises a voice recognition engine configured to use voice recognition to compare the voice command to the verification data to authenticate the user.

5. The system of claim 1, wherein:
the user input is a biometric signal; and
the virtual reality user device comprises a biometric engine configured to compare the biometric signal to the verification data to authenticate the user.

6. The system of claim 1, wherein:
the virtual reality user device comprises a gesture recognition engine configured to identify gestures performed by the user; and
identifying the selected transfer option from the one or more transfer options comprises identifying a gesture performed by the user to indicate the transfer option selection.

7. The system of claim 1, wherein:
the virtual reality user device comprises a voice recognition engine configured to identify voice commands performed by the user; and
identifying the selected transfer option from the one or more transfer options comprises identifying a voice command performed by the user to indicate the transfer option selection.

8. A virtual reality overlaying method comprising:
receiving, by an electronic transfer engine implemented by one or more processors of a virtual reality user device, a user input identifying a user;
comparing, by the electronic transfer engine, the user input to verification data stored in a memory of the virtual reality user device to authenticate the user;
identifying, by the electronic transfer engine, a user token for the user in response to authenticating the user;
sending, by the electronic transfer engine, the user token comprising the user identifier to a remote server, wherein the user token requests virtual data for the user comprising a document, a status tag for the document identifying the current status of the document, and one or more transfer options;
receiving, by a transfer management engine of the remote server, the user token;
identifying, by the transfer management engine, account information for the user based on the user token;
obtaining, by the transfer management engine, the document for the user based on the account information;
determining, by the transfer management engine, whether the document is unpaid based on the account information;
linking, by the transfer management engine, the document with the status tag indicating the document is unpaid in response to determining that the document is unpaid;
determining, by the transfer management engine, the one or more transfer options for the user based on the account information;
sending, by the transfer management engine, the virtual data to the virtual reality user device;
receiving, by the electronic transfer engine, the virtual data for the user;
determining, by the electronic transfer engine, whether the status tag indicates the document is unpaid;
presenting, by a virtual overlay engine implemented by the one or more processors, the document in a virtual reality environment;
overlaying, by the virtual overlay engine, the status tag onto the document in the virtual reality environment;
presenting, by the virtual overlay engine, the one or more transfer options for the document in the virtual reality environment when the status tag indicates the document is unpaid;
identifying, by the electronic transfer engine, a selected transfer option from the one or more transfer options; and
sending, by the electronic transfer engine, a message identifying the selected transfer option to the remote server.

9. The method of claim 8, wherein the one or more transfer options indicate:
a plurality of payment accounts; and
a suggested payment date for each of the plurality of payment accounts.

10. The method of claim 8, wherein identifying account information for the user based on the user identifier comprises requesting at least a portion of the account information from a third-party database.

11. The method of claim 8, wherein:
the user input is a voice command; and
comparing the user input to verification data comprises employing a voice recognition engine to use voice recognition to compare the voice command to the verification data to authenticate the user.

12. The method of claim 8, wherein:
the user input is a biometric signal; and
comparing the user input to verification data comprises employing a biometric engine to compare the biometric signal to the verification data to authenticate the user.

13. The method of claim 8, wherein identifying the selected transfer option from the one or more transfer options comprises employing a gesture recognition engine to identify a gesture performed by the user to indicate the transfer option selection.

14. The method of claim 8, wherein identifying the selected transfer option from the one or more transfer options comprises employing a voice recognition engine to identify a voice command performed by the user to indicate the transfer option selection.

15. A virtual reality user device for a user comprising:
a display configured to present a virtual reality environment to the user;
a memory operable to store:
verification data used to authenticate one or more users; and
user tokens uniquely identifying each of the one or more users;
one or more processers operably coupled to the display and the memory, and configured to implement:
an electronic transfer engine configured to:
receive a user input identifying the user;
compare the user input to the verification data to authenticate the user;
identify a user token for the user in response to authenticating the user;
send the user token to a remote server, wherein the user token requests virtual data for the user comprising:
a document;
a status tag for the document identifying the current status of the document; and
one or more transfer options;
receive the virtual data for the user in response to sending the user token, wherein the virtual data; and
determine whether the status tag indicates the document is unpaid;
a virtual overlay engine configured to:
present the document in the virtual reality environment;
overlay the status tag onto the document in the virtual reality environment; and
present the one or more transfer options for the document in the virtual reality environment when the status tag indicates the document is unpaid; and
the electronic transfer engine further configured to:
identify a selected transfer option from the one or more payment options; and
send a message identifying the selected transfer option to the remote server.

16. The apparatus of claim 15, wherein the one or more transfer options indicate:
a plurality of payment accounts; and
a suggested payment date for each of the plurality of payment accounts.

17. The apparatus of claim 15, wherein:
the user input is a voice command; and
the virtual reality user device comprises a voice recognition engine configured to use voice recognition to compare the voice command to the verification data to authenticate the user.

18. The apparatus of claim 15, wherein:
the user input is a biometric signal; and
the virtual reality user device comprises a biometric engine configured to compare the biometric signal to the verification data to authenticate the user.

19. The apparatus of claim 15, wherein:
the virtual reality user device comprises a gesture recognition engine configured to identify gestures performed by the user; and
identifying the selected transfer option from the one or more transfer options comprises identifying a gesture performed by the user to indicate the transfer option selection.

20. The apparatus of claim 15, wherein:
the virtual reality user device comprises a voice recognition engine configured to identify voice commands performed by the user; and
identifying the selected transfer option from the one or more transfer options comprises identifying a voice command performed by the user to indicate the transfer option selection.
